(19) United States
(12) Patent Application Publication
(10) Pub. No.: US 2022/0078071 A1
(43) Pub. Date: Mar. 10, 2022

(54) DEVICE AND METHOD FOR MONITORING COMMUNICATION NETWORKS

(71) Applicant: HUAWEI TECHNOLOGIES CO., LTD., Shenzhen (CN)

(72) Inventors: Alexandros AGAPITOS, Dublin (IE); Longfei CHEN, Hangzhou (CN); Aleksandar MILENOVIC, Dublin (IE)

(21) Appl. No.: 17/529,541

(22) Filed: Nov. 18, 2021

Related U.S. Application Data
(63) Continuation of application No. PCT/EP2020/059898, filed on Apr. 7, 2020.

(51) Int. Cl. H04L 12/24

(52) U.S. Cl. CPC H04L 41/0631; H04L 41/0609; H04L 41/16

(57) ABSTRACT

A device and method for monitoring a communication network that includes obtaining a dataset from a plurality of data sources in the communication network, wherein the dataset comprises a plurality of entities, wherein one or more relationships exist between one or more of the entities of the plurality of entities; obtaining a trained model, wherein the trained model comprises information about the plurality of entities and the one or more relationships; and/or transforming the dataset, based on the trained model, to obtain a transformed dataset; wherein, the transformed dataset comprises a vector space representation of each entity of the plurality of entities, and/or wherein vector space representations of related entities of the plurality of entities are closer to each other in a vector space than vector space representations of unrelated entities of the plurality of entities.

### CROSS-REFERENCE TO RELATED APPLICATIONS

This application is a continuation of International Application No. PCT/EP2020/059898, filed on Apr. 7, 2020, the disclosure of which is hereby incorporated by reference in its entirety.

### TECHNICAL FIELD

The present disclosure relates generally to communications networks, and particularly to monitoring communication networks. To this end, a device and a method for monitoring a communication network are disclosed. For example, the disclosed device and method may support performing a Root Cause Analysis (RCA), and/or identifying a root cause of a problem, and/or identifying a remediation action to fix a network problem.

### BACKGROUND

Generally, communication networks (e.g., telecommunication networks) include many components running in a complex environment. Moreover, communication networks are vulnerable to problems (such as faults and/or incidents) that may occur, for example, due to hardware or software configurations, or changes in the communication networks, etc.

Conventional devices and methods for performing RCA are based on rules that map certain network fault states to the root cause of the problem. For example, such rules may be provided by domain experts (e.g., by human supervision), or may be extracted from data using a rule mining algorithm, etc.

For instance, some conventional devices may construct a topology graph based on network elements of the communication network, and may further produce a fault propagation model, e.g., it may be based on a fault (alarm) propagation model that is overlaid on top of the constructed topology graph. Fault (alarm) propagation models may be constructed in the form of rules that specify a chain that for a given fault, alarms are propagated from one network element to the next. Furthermore, for an alarm that has occurred in a node of the communication network, the fault propagation model is used to traverse the network topology until the node that generated the root alarm is reached.

However, such conventional devices have some issues. For example, constructing and maintaining the fault (alarm) propagation graph may be challenging, as the network topology may evolve over time. Furthermore, some alarms may depend on two or more alarms (e.g., there may be one-to-many relationships between alarm and alarm-propagation paths), which may result in an issue to traverse the topology graph, for example, in case of simultaneous network faults. Such issues may further hinder identifying the root cause of problems.

Moreover, some conventional devices are based on supervised learning that may use historical training information to train models that classify alarms as root or derived alarms. For instance, a set of labelled examples may be provided by human experts. Moreover, a classifier may be trained which may recognize root alarms in real-time (e.g., it may classify each alarm as root alarm or derived alarm). However, such conventional devices have an issue with identifying the root cause of the problem. For instance, it may be difficult to achieve combinatorial generalization, e.g., the device may be trained in a given situation and may have an issue for predicting the root cause under a similar situation that is not included in the training data.

### SUMMARY

In view of the above-mentioned problems and disadvantages, embodiments of the present disclosure aim to improve conventional devices and methods for monitoring a communication network. One of the objectives is to provide a device and a method that can support performing RCA and/or identifying a root cause of a problem (fault or incident) and/or recommending a fault rectification action. The device and method should obtain information or a dataset, which can be used for identifying root causes of problems in the communication network. The device and method should be able to provide, as an output, a RCA or a recommendation of a rectification action regarding the problem.

The above mentioned objectives are achieved by the embodiments of the present disclosure as described in the enclosed independent claims. Advantageous implementations of the embodiments of the present disclosure are further defined in the dependent claims.

A first aspect of the present disclosure provides a device for monitoring a communication network, the device being configured to obtain a dataset from a plurality of data sources in the communication network, wherein the dataset comprises a plurality of entities, wherein one or more relationships exist between some or all of the entities of the plurality of entities; obtain a trained model, wherein the trained model comprises information about the plurality of entities and the one or more relationships; and transform the dataset, based on the trained model, to obtain a transformed dataset, wherein the transformed dataset comprises a vector space representation of each entity of the plurality of entities, wherein vector space representations of related entities of the plurality of entities are closer to each other in the vector space than vector space representations of unrelated entities of the plurality of entities.

The device may be, or may be incorporated in, an electronic device such as a computer, a personal computer (PC), a tablet, a laptop, a network entity, a server computer, a client device, etc.

The device may be used for monitoring the communication network. The monitoring may include performing a RCA, identifying the root cause of a problem, etc. In particular, by providing the transformed dataset, correlated entities can be identified, and problems and root causes of problems can be easier identified.

In the following, the terms “incident” and “fault” and “problem” are used interchangeably, without limiting the present disclosure to a specific term or definition.

The device may obtain a dataset (for example, it may be a big data) which may comprise the plurality of entities. Further, the plurality of entities may be, for example, an alarm, a key performance indicator (KPI) value, a configuration management parameter, and log information.

In some embodiments, the device may obtain a trained model. The trained model may be any model, for example, it may be based on a machine learning model, a deep learning model, etc. Furthermore, the device may obtain the transformed dataset based on the dataset and the trained model. The transformed dataset may comprise the vector space representation of the plurality of entities. The vector space representation may be, for example, a real-valued vector in a three-dimensional vector space (hereinafter also referred to as, “a latent space”).

In some embodiments, in the vector space, vector space representations (e.g., points in the latent space, coordinates in space) of related entities are closer to each other. The related entities may be, for example, the entities that have a direct relationship between them. In some embodiments, there may be three types of relationships between the entities, namely association, correlation, and causality, without limiting the present disclosure to a specific relationship.

According to some embodiments, the device may perform a knowledge management by a Knowledge Graph (KG). For example, the device may obtain a dataset, wherein the dataset is based on graph-structured data. For instance, the dataset may comprise a knowledge graph having a plurality of entities. Moreover, rules and the classifications may be represented based on relationships between (among) the entities, which may allow semantic matching (distance-based incident classification of root cause) and inference tasks (for example, the device may determine (predict) missing relationships between different entities using other types of relationships present in the KG).

According to some embodiments, the device may perform an automated RCA and recommendation of a remediation action to overcome an incident. For example, the device may take into account a holistic view of the network state (e.g., the KPI, alarms, configuration parameters), and may generalize across different operator networks.

According to some embodiments, the device may be able to perform a (full) automation of the RCA of incidents (faults) in telecommunication networks.

In an implementation form of the first aspect, entities in the dataset that have a relationship to each other are transformed such that their vector space representations in the vector space have a smaller distance between each other, and/or entities in the dataset that have no relationship to each other are transformed such that their representations in the vector space have a larger distance between each other.

In a further implementation form of the first aspect, the device is further configured to correlate the vector space representation of each entity in the vector space of the transformed dataset into groups; and identify one or more incidents from the groups based on a trained classifier.

According to some embodiments, the correlation may be based on multi-source correlation rules. In particular, the device may learn the multi-source correlation rules based on a frequent-pattern mining algorithm like FP-growth algorithm, a logistic regression algorithm, etc. For example, the device may use the multi-source correlation rules and may further group the heterogeneous entities (i.e., alarms, KPIs, configuration management parameters, operation log) into the incident candidates (e.g., each group may be an incident candidate).

In a further implementation form of the first aspect, the device is further configured to correlate the vector space representation of each entity into the groups based on a multi-source correlation rule and/or heuristic information.

According to some embodiments, the latent variables (e.g., KPI values, configuration parameters, etc.) that are relevant together and may be used in classifying an incident are captured in the forms of entities in a KG. The device may use the multi-source correlation rules to group heterogeneous objects, i.e., alarms, KPI anomalies, operation events, configuration parameters into an incident candidate. This may allow the device (e.g., a decision-making algorithm in the device) to leverage on a piece of richer information than the information that is provided when looking solely at alarms.

In an embodiment, the device is further configured to identify, for each of the one or more identified incidents, one or more of an incident type, a root cause of the incident, and an action to rectify the incident.

In an embodiment, the identifying of the one or more incidents from the groups is further based on topology information about the data sources in the communication network.

For example, the device may obtain (e.g., receive from the communication network) the topology information which may be a graph-based representation of the topology of network entities.

In an embodiment, the trained model further comprises a plurality of information triplets, each information triplet comprising a first entity, a second entity, and a relationship between the first entity and the second entity.

For example, a triplet may comprise the first entity (a type of entity such as an incident type), the second entity (a type of entity such as alarm type), and a relationship between the incident and the alarm. The relationship may be, e.g., “is associated with”, “has a”, “requires a”, etc.

In an embodiment, the trained model further comprises, for each entity of the plurality of entities, information on at least one of a type of the entity, an incident associated with the type of the entity, an action to overcome the incident, and a root cause of the incident.

In an embodiment, the trained model further comprises graph-structured data.

For example, the trained model may comprise information which may be in a form of relationships between entities (e.g., incident types, alarm types, KPI anomaly types, physical or logical connectivity pattern of network entities that are involved in the incident, configuration management parameters, operation events, root causes, remediation-actions, etc.) that revolve around an incident type.

The device may obtain (store) such information in the form of triplets (having a first entity, a second entity and a relationship) in a graph-structured data (e.g., the nodes represent entities, and edges represent the relationship). Moreover, the device may process the graph-structured data by means of a KG embedding algorithm in order to extract features of entity types (i.e., alarm types) and may further use these features for classification (i.e., root cause classification, remediation action classification).

In an embodiment, each of the plurality of entities is one of an alarm, a key performance indicator value, a configuration management parameter, and log information.

In an embodiment, the device is further configured to transform the dataset based on the trained model by using a deep graph auto-encoder.

In an embodiment, the trained classifier is based on a soft nearest-neighbor classifier.

For example, the device may represent each incident candidate by an average vector (i.e., incident centroid) of the entities that are related to the incident candidate. Moreover, the soft nearest-neighbor classifier may classify (group, cluster) the heterogeneous data into incident candidates based on a probabilistic assignment of the heterogeneous data to the closest incident centroid.

According to some embodiments, the effect of one-to-many relationships between an alarm and an incident type, and the effect of alarm causality graphs with a branching factor of more than one may be mitigated. For example, the device may use a graph neural network classifier that may obtain as input the features that are extracted by embedding the KG. The graph neural networks may enable a combinatorial generalization. The trained classification model takes as input the features that correspond to the entities that compose an incident candidate and performs probabilistic mapping to the, e.g., the root cause of the incident, the remediation action, etc.

A second aspect of the present disclosure provides a method for monitoring a communication network, the method comprising obtaining a dataset from a plurality of data sources in the communication network, wherein the dataset comprises a plurality of entities, wherein one or more relationships exist between some or all of the entities of the plurality of entities; obtaining a trained model, wherein the trained model comprises information about the plurality of entities and the one or more relationships; and transforming the dataset, based on the trained model, to obtain a transformed dataset, wherein the transformed dataset comprises a vector space representation of each entity of the plurality of entities, wherein vector space representations of related entities of the plurality of entities are closer to each other in the vector space than vector space representations of unrelated entities of the plurality of entities.

In an embodiment, entities in the dataset that have a relationship to each other are transformed such that their vector space representations in the vector space have a smaller distance between each other, and/or entities in the dataset that have no relationship to each other are transformed such that their vector space representations in the vector space have a larger distance between each other.

In an embodiment, the method further comprises correlating the vector space representation of each entity in the vector space of the transformed dataset into groups; and identifying one or more incidents from the groups based on a trained classifier.

In an embodiment, the method further comprises correlating the vector space representation of each entity into the groups based on a multi-source correlation rule and/or heuristic information.

In an embodiment, the method further comprises identifying, for each of the one or more identified incidents, one or more of an incident type, a root cause of the incident, and an action to overcome the incident.

In an embodiment, the identifying of the one or more incidents from the groups is further based on topology information about the data sources in the communication network.

In an embodiment, the trained model further comprises a plurality of information triplets, each information triplet comprising a first entity, a second entity, and a relationship between the first entity and the second entity.

In an embodiment, the trained model further comprises, for each entity of the plurality of entities, information on at least one of a type of the entity, an incident associated with the type of the entity, an action to overcome the incident, and a root cause of the incident.

In an embodiment, the trained model further comprises graph-structured data.

In an embodiment, each of the plurality of entities is one of an alarm, a key performance indicator value, a configuration management parameter, and log information.

In an embodiment, the method further comprises transforming the dataset based on the trained model by using a deep graph auto-encoder.

In an embodiment, the trained classifier is based on a soft nearest-neighbor classifier.

A third aspect of the present disclosure provides a computer program comprising a program code for performing the method according to the second aspect or any of its implementation forms.

A fourth aspect of the present disclosure provides a non-transitory storage medium storing executable program code which, when executed by a processor, causes the method according to the second aspect or any of its implementation forms to be performed.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above mentioned aspects and implementation forms will be explained in the following description of specific embodiments in relation to the enclosed drawings, in which

FIG. 1 depicts a schematic view of a device for monitoring a communication network, according to some embodiments of the disclosure;

FIG. 2 depicts a schematic view of the device identifying an incident candidate of the communication network, according to some embodiments of the disclosure;

FIG. 3 depicts a schematic view of the device for performing an RCA comprising identifying an incident and recommending an action to overcome the incident, during an inference phase, according to some embodiments of the disclosure;

FIG. 4 depicts a schematic view of the device obtaining the trained model and the trained classifier, during a training phase, according to some embodiments of the disclosure;

FIG. 5 depicts a schematic view of the device identifying an incident candidate based on a trained model being a KG embedding model and a trained classifier being a deep graph convolution network, according to some embodiments of the disclosure;

FIG. 6 depicts a schematic view of a diagram illustrating a knowledge graph comprising a plurality of information triplets, according to some embodiments of the disclosure;

FIG. 7 depicts a schematic view of a diagram illustrating obtaining a transformed dataset based on the trained model, according to some embodiments of the disclosure;

FIG. 8 depicts a schematic view of a diagram illustrating generating a plurality of incident centroids, according to some embodiments of the disclosure;

FIG. 9 depicts a schematic view of a diagram illustrating generating an incident candidate based on multi-source correlation rules, according to some embodiments of the disclosure;

FIG. 10 depicts a schematic view of a diagram illustrating a procedure for identifying an incident candidate, according to some embodiments of the disclosure;

FIGS. 11A-B depict diagrams illustrating the resource footprints when training the device, according to some embodiments of the disclosure; and

FIG. 12 depicts a schematic view of a flowchart of a method for monitoring a communication network, according to some embodiments of the disclosure.

### DETAILED DESCRIPTION OF EMBODIMENTS

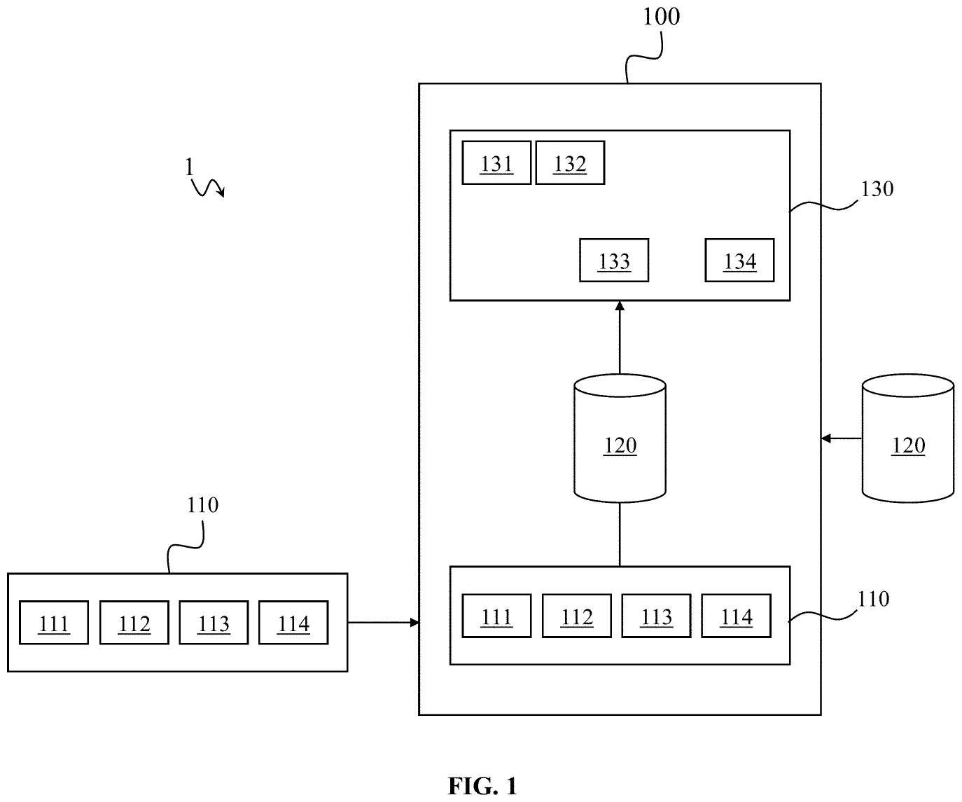

FIG. 1 shows a schematic view of a device 100 for monitoring a communication network 1, according to some embodiments of the disclosure.

The device 100 may be, or may be incorporated and/or included in, an electronic device, for example, a computer, a laptop, a network entity, etc.

The device 100 may be configured to obtain (e.g., retrieve, receive, gather) a dataset 110 from a plurality of data sources in the communication network 1. The dataset 110 may comprise a plurality of entities 111, 112, 113, 114, wherein one or more relationships exist between some or all of the entities of the plurality of entities 111, 112, 113, 114.

The device 100 may be configured to obtain a trained model 120. In some embodiments, the trained model 120 comprises information about the plurality of entities 111, 112, 113, 114 and/or the one or more relationships.

The device 100 may be configured to transform (e.g., modify, convert, adjust) the dataset 110, based on the trained model 120, to obtain a transformed dataset 130. In some embodiments, the transformed dataset 130 comprises a vector space representation 131, 132, 133, 134 of each entity of the plurality of entities 111, 112, 113, 114.

For example, the transformed dataset 130 may comprise a vector space representation 131 for the entity 111. In some embodiments, the transformed dataset 130 comprises a vector space representation 132 for the entity 112, a vector space representation 133 for the entity 113, and/or a vector space representation 134 for the entity 114.

In some embodiments, the vector space representations 131, 132 of related entities 111, 112 of the plurality of entities 111, 112, 113, 114, 115 may be closer to each other in the vector space than vector space representations 133, 134 of unrelated entities 113, 114 of the plurality of entities 111, 112, 113, 114.

The device 100 may comprise a processing circuitry (not shown in FIG. 1) configured to perform, conduct or initiate the various operations of the device 100 described herein. The processing circuitry may comprise hardware and/or software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes the device 100 to perform, conduct or initiate the operations or methods described herein.

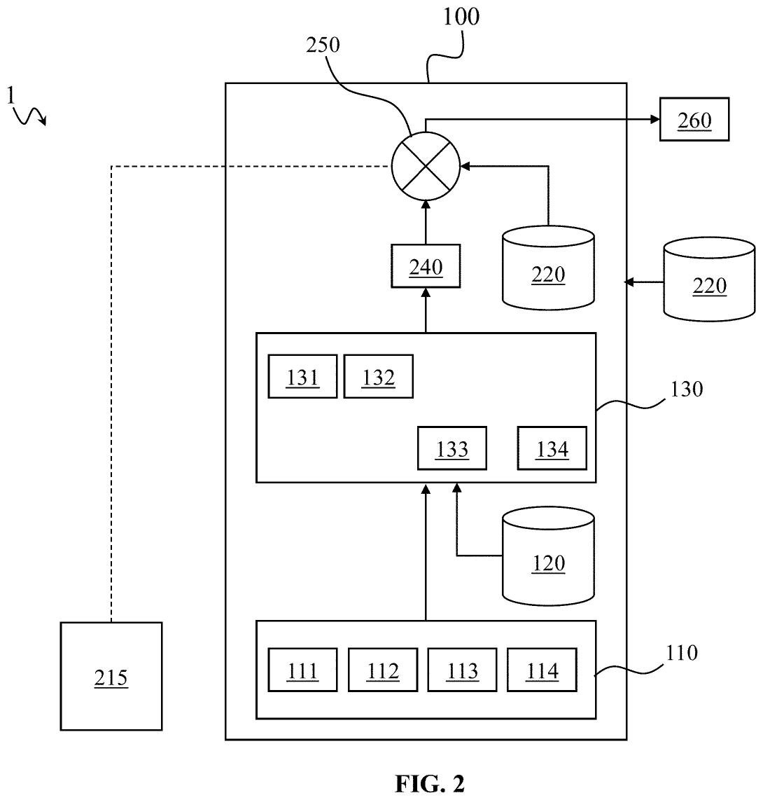

FIG. 2 shows a schematic view of the device 100 identifying an incident candidate 260 of the communication network 1, according to some embodiments of the disclosure.

For example, the device 100 may be configured to obtain the dataset 110 and/or the trained model 120. The trained model 120 may comprise information about the plurality of entities 111, 112, 113, 114 and/or the one or more relationships. In some embodiments, the device 100 may be configured to transform the dataset 110 based on the trained model 120 to obtain a transformed dataset 130.

In some embodiments, the entities 111, 112 in the dataset 110 that have a relationship to each other are transformed such that their vector space representations 131, 132 in the vector space have a smaller distance between each other, and the entities 113, 114 in the dataset 110 that have no relationship to each other are transformed such that their representations (e.g., vector space representations 131, 132) in the vector spaces have a larger distance between each other.

The plurality of entities 111, 112, 113, 114 may be, for example, alarms incident, alarm event streams, KPI time-series, event logs, and/or Configuration Parameter (CP) specifications.

Next, in some embodiments, the device 100 may correlate the vector space representation of each entity 111, 112, 113, 114 in the vector space of the transformed dataset 130 into groups 240. The groups 240 may include one or more groups.

In some embodiments, the device 100 may obtain a trained classifier 220. In some embodiments, the device 100 may comprise a decision unit 250, which may identify (e.g., determine, detect) one incident 260 from the groups 240 based on the trained classifier 220. In some embodiments, the device 100 may provide (e.g., deliver, send) the identified incident 260.

For instance, the device 100 may correlate the vector space representation of each entity 111, 112, 113, 114 into the groups 240 based on a multi-source correlation rule.

For example, the multi-source correlation rule may be applied to discover relationships among entities (e.g., alarms series, KPI series, operation logs, configuration parameter logs) using telemetry and/or other data generated by the communication network. In some embodiments, the multi-source correlation rule (e.g., a trained model) may automatically extract statistical relationships between entity variables, and populate a knowledge graph.

The identifying of the incident 260 from the groups 240 may be based on obtaining topology information 215 about the data sources in the communication network 1. For example, the device 100 may obtain the topology information 215. In some embodiments, the decision unit 250 may identify the incident 260 from the groups 240 based on the trained classifier 220 and/or the obtained topology information 215.

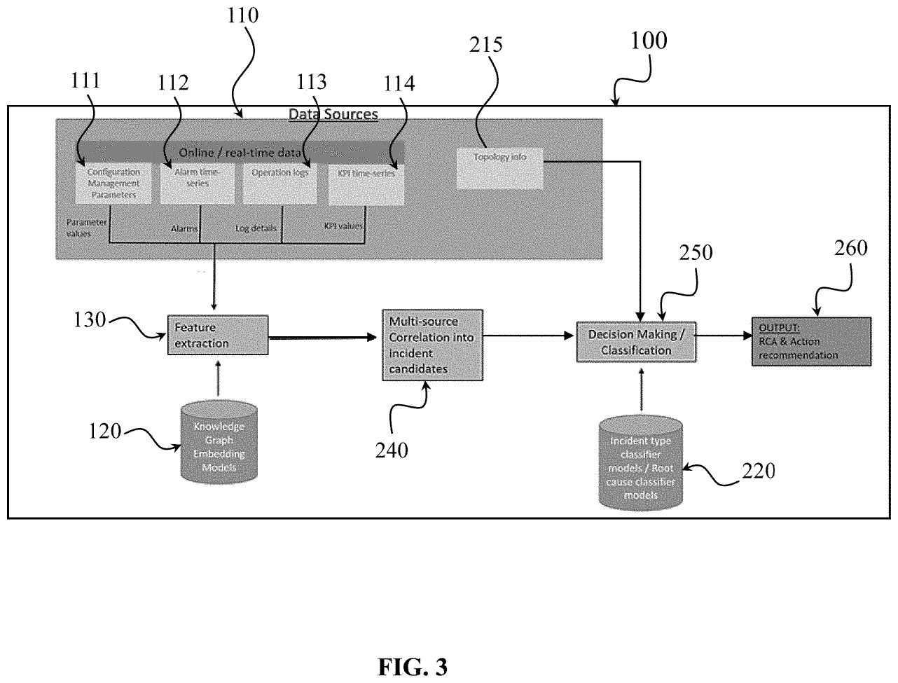

Reference is now made to FIG. 3, which depicts a schematic view of the device 100 for performing an RCA, comprising identifying an incident and/or recommending an action to overcome the incident, during an inference phase, according to some embodiments of the disclosure.

The device 100 may be configured to obtain a dataset 110 from a plurality of data sources in the communication network 1. The dataset 110 may be obtained during an online phase (being real-time data).

For example, the device 100 may collect (e.g., gather, acquire, assemble) multi-source real-time streaming data for a plurality of entities including configuration management parameter values and changes 111, alarm time-series 112, operation logs 113, and KPI time-series 114.

The device 100 may obtain a trained model 120 which is based on (e.g., comprises) a knowledge graph embedding model.

The device 100 may transform the dataset 110 (e.g., including configuration management parameter values and changes 111, alarm time-series 112, operation logs 113, and KPI time-series 114), based on the knowledge graph embedding model (trained model 120) to obtain the transformed dataset 130. For instance, transforming the dataset for obtaining the transformed dataset 130 may comprise feature extraction based on the dataset 110 (e.g., by using raw multisource data) and/or invoking the knowledge graph embedding model (trained model 120). The device 100 may initially invoke multi-source correlation rules or grouping heuristics rules based on the domain knowledge.

In some embodiments, the device 100 may group the multi-source data into incident candidates. For instance, the device 100 may perform a feature extraction of the entities or the relationships stored in a knowledge graph by the knowledge graph embedding. The device 100 may perform a deep learning technique to automatically extract features to represent the entities and/or relationships stored in the knowledge graph, etc.

For instance, the device 100 may correlate the extracted features in the transformed dataset 130 into the groups 240 (e.g., multi-source correlation into groups of incident candidates) based on a multi-source correlation rule. For example, the device 100 may use the entities of the incident candidate 260 as input, and invoke KG embedding models to create vector representation of the entities (i.e., alarms, KPI values, Operation logs, CM parameter values) that make up the incident candidate.

The device 100 may also obtain the topology information 215 of the communication network 1 and/or the trained classifier 220. The trained classifier 220 may be based on an incident type classifier model or root cause classifier model.

The decision unit 250 may identify incident candidate 260 from the groups 240 based on the trained classifier 220 and/or the groups 240, for example, by correlation of transformed multi-source data (e.g., alarms, KPI values, configuration management parameters) into groups that represent incident candidates. For instance, the device may aggregate (e.g., collect, combine) incident candidate embedding with incident candidate topology into an input vector that is passed (e.g., delivered, sent, provided) to the incident type or a root cause classifier.

In some embodiments, the device 100 may provide (e.g., output, deliver, produce) an identified incident 260, the result of RCA, and/or recommend an action to overcome the identified incident, etc.

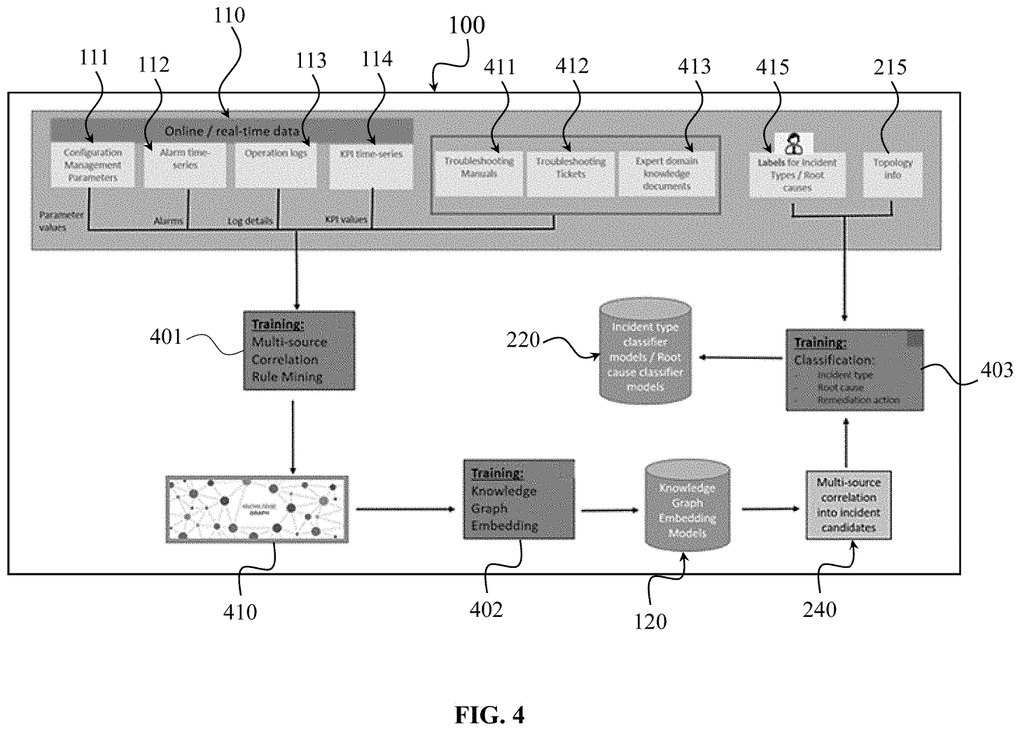

FIG. 4 depicts a schematic view of the device 100 obtaining the trained model 120 and the trained classifier 220, during a training phase of the device 100, according to some embodiments of the disclosure.

During the training phase, the device 100 may comprise one or more training modules including a training module 401, a training module 402, and a training module 403.

The training module 401 may perform a training procedure based on a multi-source correlation rule mining process.

For example, the device 100 (the training module 401) may apply association rule mining algorithms to (automatically) discover association relationships (e.g., in the form of rules) between historical series of heterogeneous entities of the dataset 110 (including entities (e.g., the CM parameters 111, alarm time-series 112, operation event series 113, and KPI time-series 114)).

For example, the device 100 may obtain knowledge by extracting knowledge from historical data, which may be stored in a KG 410. The KG 410 may thus comprise knowledge about the problem domain, and may further be used as a source for labelled training examples, providing relational data, etc.

The inputs of the training module 401 may be, e.g., configuration management parameters 111, alarm time-series 112, operation event series 113, and KPI time-series 114, troubleshooting manuals 411, troubleshooting tickets 412, expert domain knowledge document 413.

The outputs of the training module 401 may be, e.g., rules or a model that may associate the entities. The rules may be stored in the multi-source correlation rules repository and/or the knowledge graph 410. These rules may then be invoked during inference phase to group heterogeneous entities into groups 240 that represent incident candidates.

The training module 402 may be based on a knowledge graph embedding. The training module 402 may train models that extract useful representations of the knowledge stored in the KG 410, and use this as features of KG entities when these entities are used in downstream classification tasks.

The inputs of the training module 402 may be, e.g., adjacency matrix representation of a KG 410, in which nodes represent entities and edges represent relationships between entities. Entities and relationship types are further defined in the KG scheme.

The outputs of the training module 402 may be, e.g., a model (the trained model 120 such as the KG embedding model) that transforms KG entities (nodes in the graph) into low-dimensional real-valued vectors. The model may be stored in the knowledge graph embedding models repository.

The training module 403 may be based on a classifier, for example, the classifier may classify based on the incident type, root cause, remediation action.

In some embodiments, the device 100 may receive the training module 403, for example, by human supervision, without limiting the present disclosure.

The training module 403 may train classifiers for the tasks of incident type classification, root cause classification, remediation action classification, etc. The labelled examples may be (automatically) extracted from the KG.

The inputs of the training module 403 may be, e.g., the grouping of multi-source data (i.e., alarms 112, KPI values 114, CM parameter values 111, etc.) into incident candidates. The grouping may be performed using multi-source correlation rules, heuristics, and other domain knowledge. Incident candidate entities may then be replaced by their respective embedding (low-dimensional vectors) using the KG embedding model repository.

Moreover, the inputs of the training module 403 may be the topology information 215 of incident candidate (i.e., the topology of the network elements that generated the alarms, KPI values), label of the incident candidate 415 in terms of either incident classification label, root cause label associated with the incident candidate, remediation action label.

The outputs of the training module 403 may be, e.g., one or more models (the trained classifier 220) that classifies (e.g., groups, categorizes) an incident candidate according to the incident type, the root cause of the incident, and/or the remediation action required to alleviate the problem, etc. The one or more models (i.e., the trained classifier 220) may be stored in the incident type classifiers or the root cause classifiers repository.

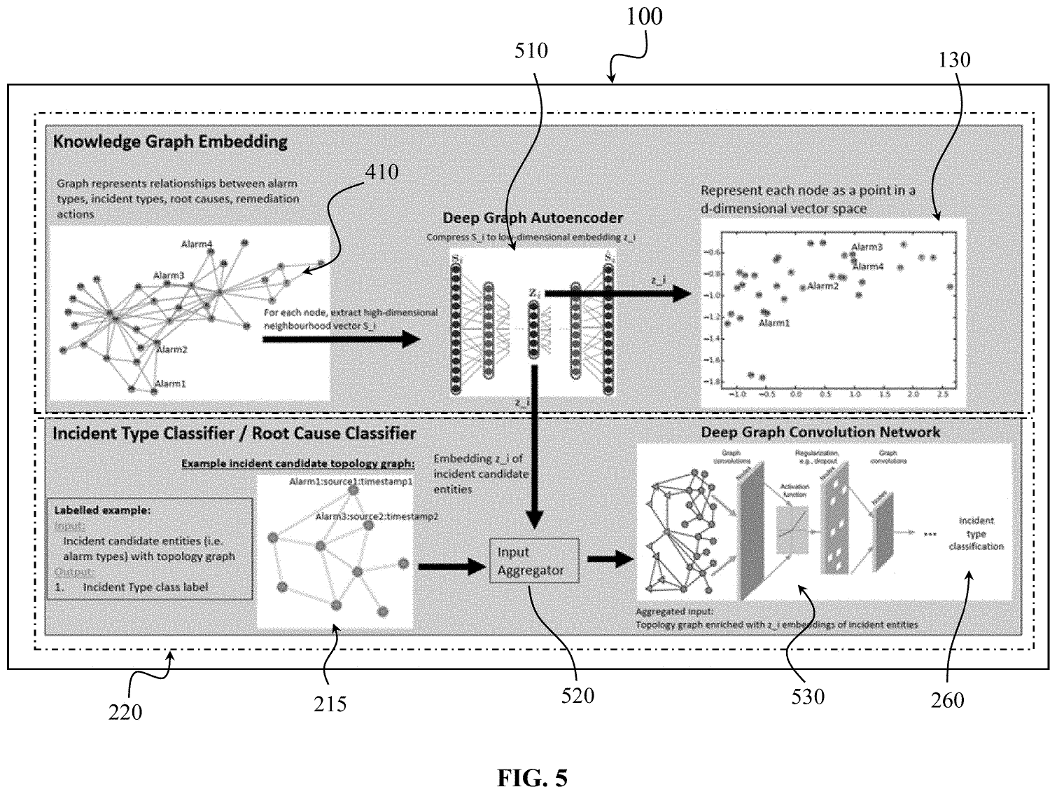

FIG. 5 shows a schematic view of the device 100 identifying an incident candidate 260 based on a trained model, wherein the trained model comprises a KG model, and a trained classifier being a deep graph convolution network, according to some embodiments of the disclosure.

The device 100 obtains the dataset 110 and may obtain the trained model 120 in the form of the KG 410. The KG 410 may be based on, for example, for the domain of fault incident management and root cause analysis in a communication network 1 that may describe entities revolving around the notion of network faults, and their interrelations organized in a graph data-structure. The entity types (e.g., alarms) and relationship types are defined in the scheme of the KG 410.

Examples of relationship types may be “associated with” (i.e., incident type is associated with an alarm), “triggers an anomaly” (i.e., an incident triggers an anomaly in a particular KPI), and “is the root cause of” (i.e., power failure is the root cause of incident X).

Moreover, facts may then be composed as triples of the form (entity_type, relationship_type, entity_type) and are stored in the KG 410. Such a knowledge representation in the form of KG 410 may enable the application of relational machine learning methods for the statistical analysis of relational data.

The device 100 may then transform the dataset 110 to the transformed dataset 130 based on the trained model 120, which comprises the KG 410. The transforming may be performed by a deep graph autoencoder 510.

The KG 410 stores information about entities (alarms) and their relationships. Entities are constituent parts of incident candidates, and therefore groups or clusters of entities may serve as input to classification and multi-source correlation models. In the domain of incident management, the majority of entities may be defined as categorical or discrete variables. The trained model 120 (e.g., the knowledge graph embedding) may obtain the feature representations. These features are learned by the trained model 120 (e.g., the knowledge graph embedding or a machine learning model) that maps semantically similar entities closer to each other in the newly transformed vector space of the transformed dataset 130.

The deep graph autoencoder 510 may extract features from the KG 410. For example, the device 100 may use relational machine learning that is trained on graph-structured data (stored in the KG 410) to learn to extract features based on the relationships and interdependencies between information objects associated with a communication network fault incident.

In some embodiments, the device 100 comprises the trained classifier 220 which may be based on an incident type classifier or a root cause classifier which may obtain as input incident candidate entities (alarm types) and the topology information 215 and may provide (output) incident type class label.

The trained classifier 220 comprises an input aggregator 520 and a deep graph convolution network 530. The input aggregator 520 obtains the topology information 215 and an embedding of incident candidates from the deep graph autoencoder 510. In some embodiments, the deep graph convolution network 530 generates the incident candidates and identifies an incident 260.

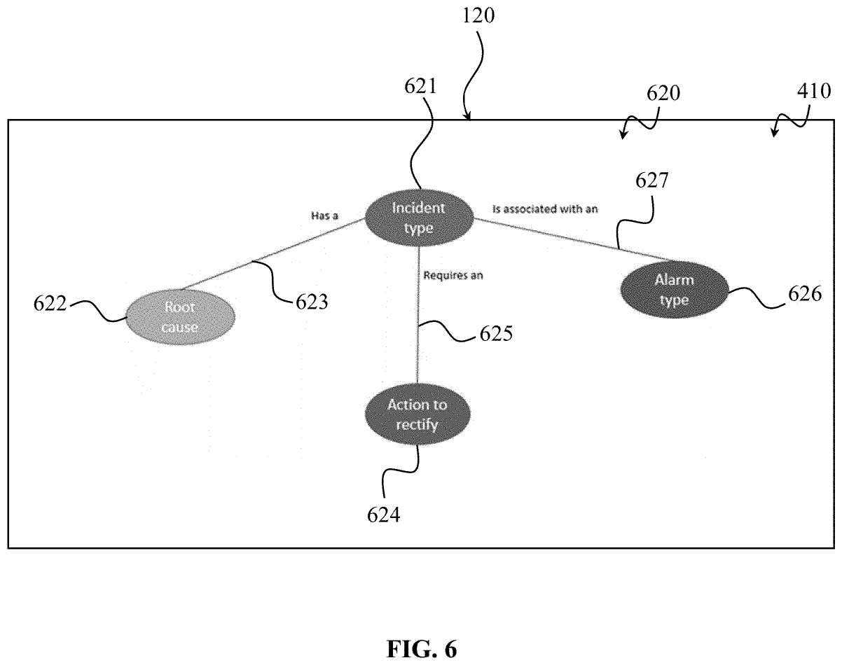

FIG. 6 shows a schematic view of a knowledge graph 410 comprising a plurality of information triplets, according to some embodiments of the disclosure.

For example, the trained model 120 of the device 100 may obtain the KG 410 depicted in FIG. 6. The KG 410 comprises the plurality of information triplets 620.

Each information triplet 620 comprises a first entity 621, a second entity 622, 624, 626, and a relationship 623, 625, 627 between the first entity 621 and the second entity 622, 624, 626.

The entities (the first entity 621, or the second entities 622, 624, 626) may be, for example, information objects, fault incident types, alarm types, KPI anomaly types, physical or logical connectivity pattern of network elements that are involved in the incident, configuration management parameters, operation events, root causes, remediation actions. The relationships 623, 625, 627 may be a relationship types such as “has a”, “requires an”, “is associated with”, etc.

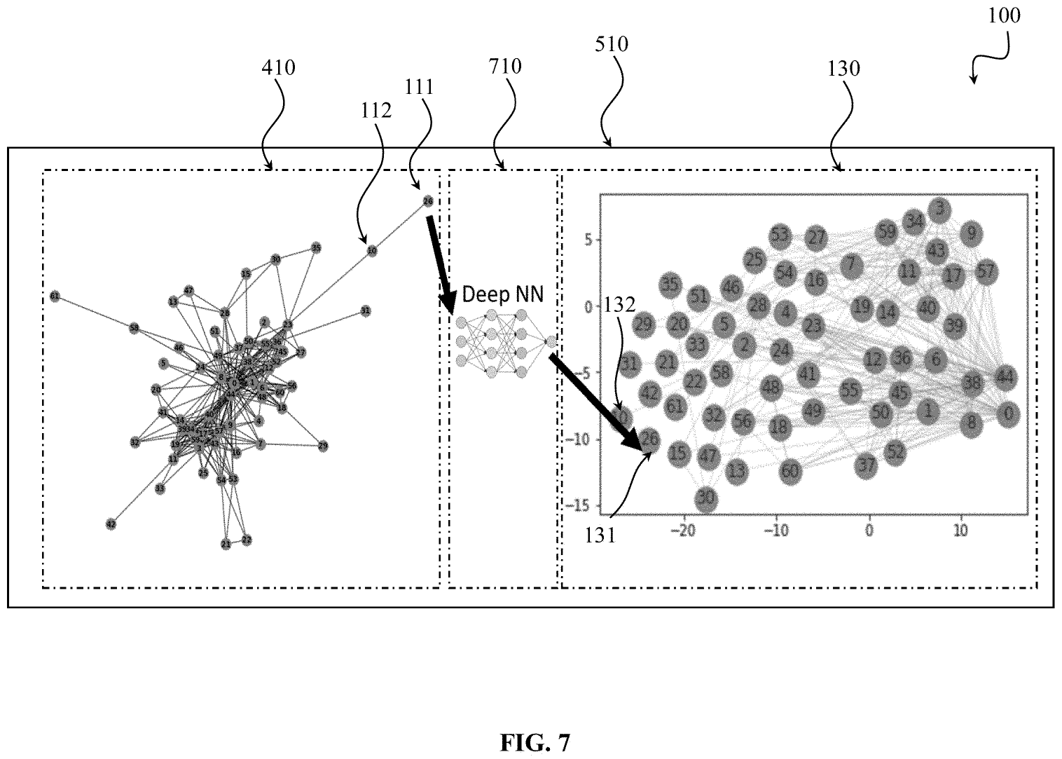

FIG. 7 shows a schematic view of a diagram illustrating obtaining a transformed dataset 130 based on the trained model 120, according to some embodiments of the disclosure.

For example, the device 100 may obtain the transformed dataset 130. The trained model 120 of the device 100 may comprise the KG 410, and the deep graph autoencoder 510, which may include a deep neural network 710 (deep NN), may be employed to transform the dataset 110 into the transformed dataset 130 based on the KG 410. The deep graph autoencoder 510 may particularly perform a feature extraction based on the KG 410 and the deep NN 710.

Deep graph autoencoder 510 may specifically transform (map) alarms (entity 111, 112) of the dataset 110, based on the KG 410, to a real-valued feature vector in the transformed dataset 130. The transformed dataset 130 is shown in a d-dimensional vector space (latent space). In some embodiments, semantically similar alarm 10 (entity 112) and alarm 26 (entity 111) may be mapped such that their vector space representations 131, 132 are closer to each other in the transformed dataset 130.

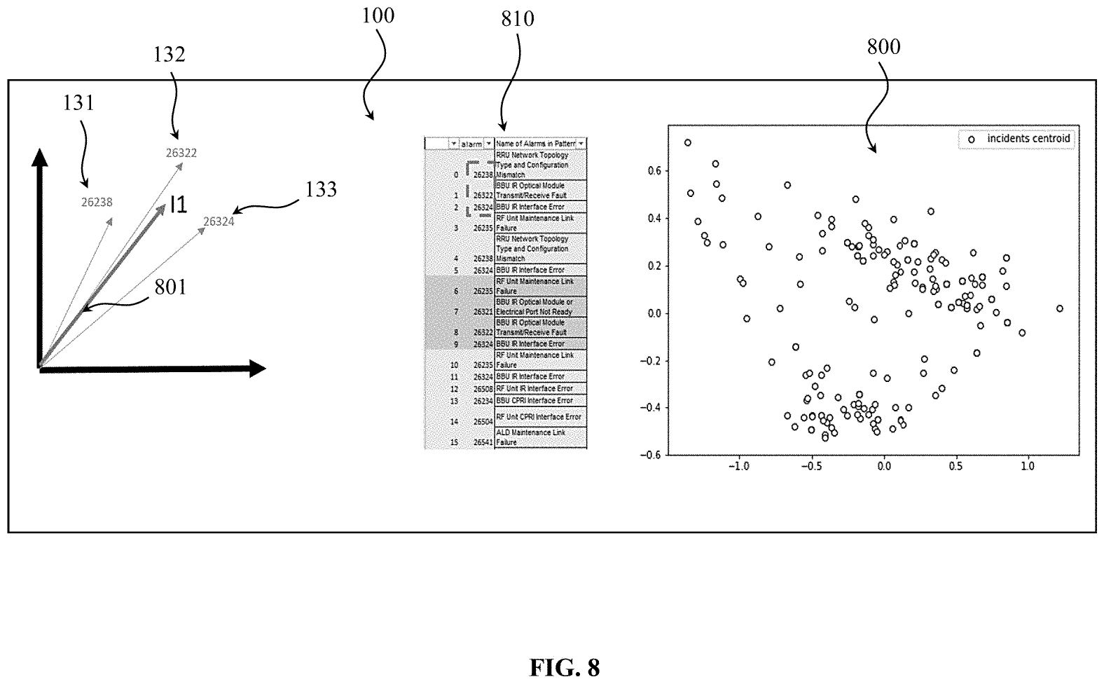

FIG. 8 shows a diagram illustrating generating a plurality of incident centroids 800, according to some embodiments of the disclosure.

The device 100 may generate the plurality of incident centroids 800. The device 100 defines incident type in terms of alarm association. The vector space representations of the alarms that are related to an incident are averaged and incident centroids 800 are generated. For example, the incident centroid 801 (I1) may be generated based on the vector space representation 131 of the first entity 111 (alarm 26238), the vector space representation 132 of the second entity 112 (alarm 26322) and the vector space representation 133 of the entity 113 (alarm 26324). The incident centroid 801 is an average of the vector space representations of alarms 26238, 26322 and 26324). In some embodiments, the device uses knowledge about the incident types and associated alarms 810 (for example, knowledge about the incident types and associated alarms 810 may be obtained from KG 410 and/or the dataset 110) and obtains the plurality of incident centroids 800.

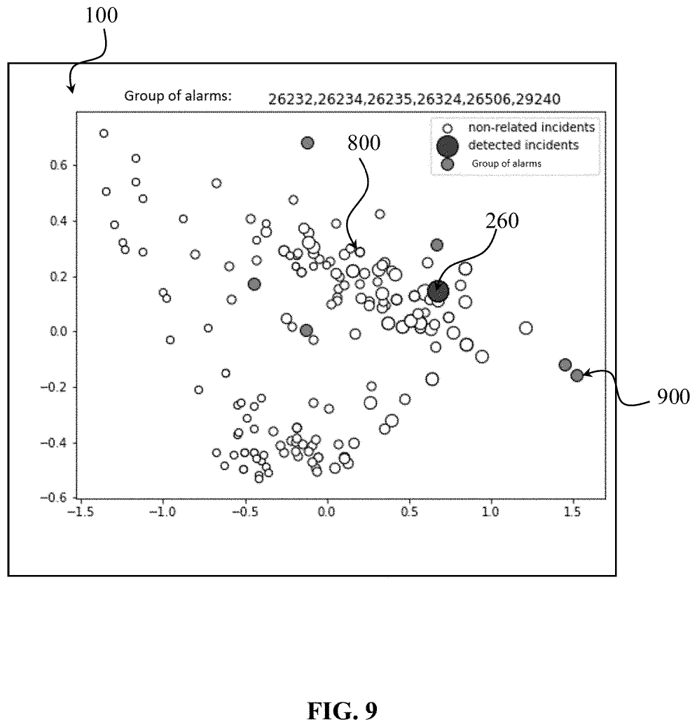

FIG. 9 shows a diagram illustrating generating an incident candidate 260 based on multi-source correlation rules, according to some embodiments of the disclosure.

The device 100 may generate the incident candidate 260. For instance, when dealing with heterogeneous entities that characterize an incident, the multi-source correlation may comprise a process of grouping or clustering of instances of such entities in the form of an incident candidate. The grouping may rely on the feature extraction perfumed based on the trained model (e.g., may be or may include the knowledge graph embedding).

In some embodiments, the multi-source correlation may be based on a soft nearest neighbor classification. For example, the device 100 may invoke deep graph autoencoder 510 for each alarm in a time-window to obtain the transformed dataset 130 (including the vector space representation of the alarms). In some embodiments, under certain incident types stored in the knowledge graph, the device 100 may obtain all the respective entities (i.e., alarm types that are present under certain network fault) and average their vector space representations to obtain “incident centroids”, which are the incident-representative vectors.

In some embodiments, the device 100, during a real-time, may use telemetry data and other network data stores and may group entities (i.e., Alarms, KPI values, CM parameters) based on a fixed time-window. The device 100 may also transform each entity in the time-window using the graph autoencoder into a vector space representation. At next, the device 100 may compute distances of each entity to each incident centroid and may further normalize distances and transform them into probabilities.

The device 100 may perform probabilistic assignment of entities into incident candidates by means of a soft nearest neighbor classifier and generate the resulting incident candidates 260.

In FIG. 9, the vector space representations 900 of a group of alarms (including alarms 26232, 26234, 26235, 26324, 26506, 29240) are indicated using filled circle (reference 900). In some embodiments, the empty circles are indicating non-related incidents. The circle indicated with reference 260 is an identified incident candidate.

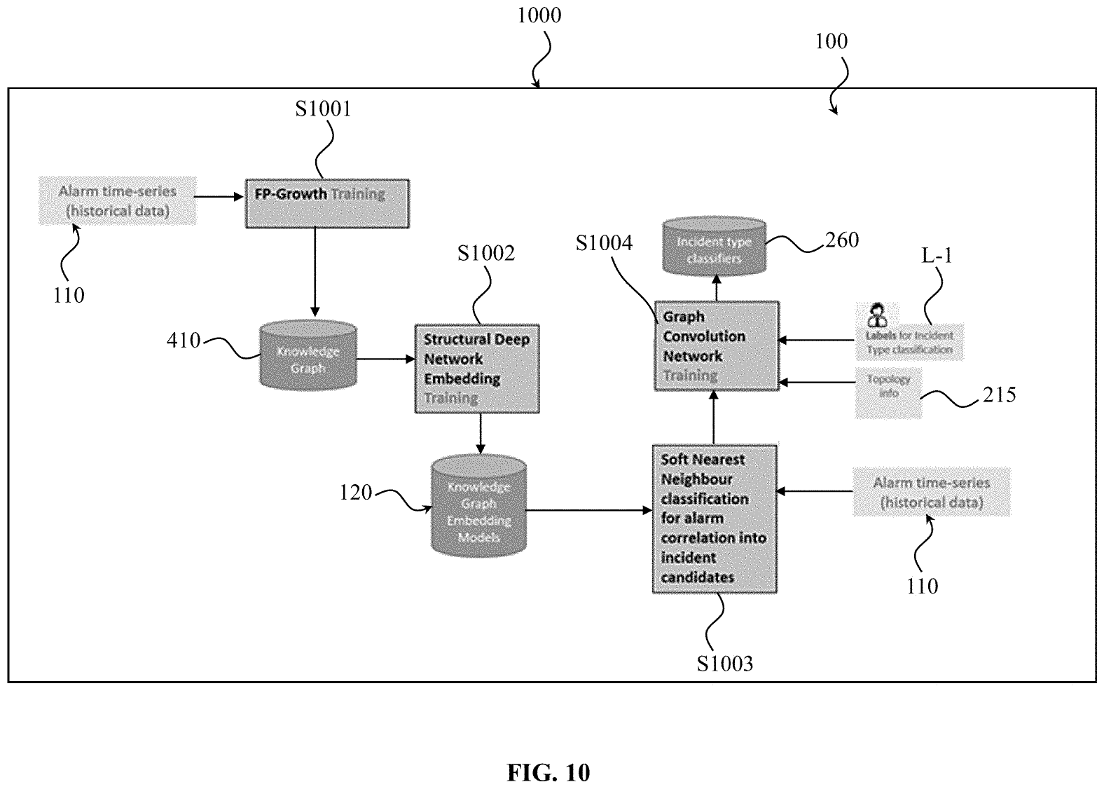

Reference is now made to FIG. 10, which is a schematic view of a procedure 1000 for identifying an incident candidate, according to some embodiments of the disclosure.

The device 100 may perform the procedure 1000.

At S1001, the device 100 may learn the multi-source correlation rules based on a frequent-pattern (FP)-growth algorithm.

For instance, the device 100 may obtain the alarms time-series historical data from the dataset 110. In some embodiments, the device 100 may use troubleshooting documentation support, documents containing domain expert knowledge and apply natural language processing (in an unstructured approach) to generate knowledge graph triplets from unstructured text.

In the KG 410, knowledge is represented in the form of a knowledge graph. The knowledge may be information about the problem domain, may be used as a source for labelled training examples (which may be used for correlation and classification), as well as providing relational data that can be used for feature extraction required in downstream machine learning tasks, i.e., multi-source correlation or clustering or classification.

At S1002, the device 100 may obtain the trained model 120. The trained model may be KG embedding model and may be obtained based on performing a structural deep network embedding process.

For instance, the device 100 apply data-driven correlation rule mining algorithms to automatically discover relationships between alarms.

At S1003, the device 100 may correlate the alarms to incident candidates based on the soft nearest neighbor classification, the KG embedding model (of the trained model 120) and the obtained dataset 110 comprising alarm time-series.

For instance, the device may 100 extract features of the entities or the relationships stored in the KG 410 by the knowledge graph embedding. Here, deep learning may be used to extract features to represent the entities and relationships stored in the knowledge graph.

At S1004, the device 100 may use a graph convolution network and may generate the incident candidates 260.

For example, the device may obtain the topology information 215 and may use the graph convolution network, for generating the incident candidates 260.

In some embodiments, the device 100 may also receive the labels L-1 and may generate the incident candidates 260 based on the received labels L-1.

In some embodiments, incident candidates may be identified to determine the root cause of the incident, recommend a remediation action to overcome the incident, etc.

The classification of an incident candidate may be done based on its root cause, a remediation action that will alleviate the problem. The final representation of the incident candidate may be determined based on information received from the topology 215 (i.e., the physical or logical connectivity pattern of the network elements that generate certain alarms), features of its constituent entities, etc.

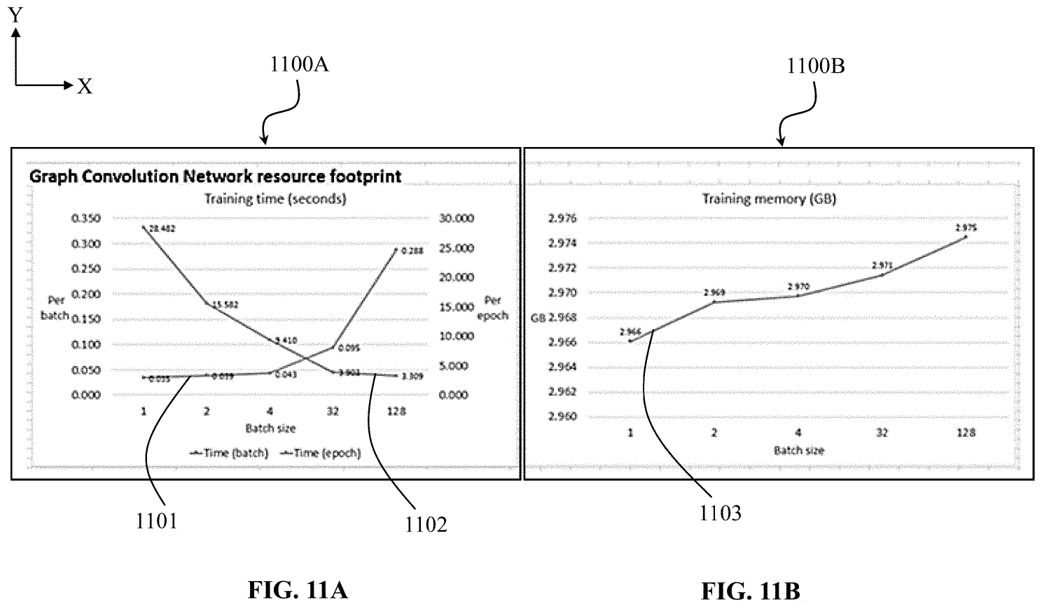

The performance of the device 100 is further discussed in FIG. 11A and FIG. 11B, which are based on a use case from Packet Transport Network domain, without limiting the present disclosure to a specific use case.

Topology information and an exemplary dataset of a Packet Transport Network are used for analyzing the performance of the device 100. For the sake of simplicity, a detailed description of the used dataset (e.g., the data sources, alarms, etc.) and topology information of the Packet Transport Network is not provided here.

The device 100 may group alarms into incident candidates, and subsequently, classify each incident candidate according to an incident type. There are 31 possible incident types in the dataset, and their distribution in the training set is highly imbalanced.

The device 100 obtains the dataset 110 comprising the alarm list that is to be organized into incident candidates which are then classified and are made of 4,535 alarms. The device 100 also obtains the topology information 215 of the network elements that serve as the source of alarms. The device 100 uses 10-fold stratified cross-validation to evaluate classification performance, and provides the mean accuracy, mean prediction, and mean recall (mean computed over 10 folds).

The device 100 uses a KG 410 scheme based on the scheme provided in FIG. 6, which specifies:
entity types: incident type, root cause, alarm type remediation-action
relationship types: “has a”, “requires an”, “is associated with”.

The device 100, in some embodiments, generates (e.g., produces) a knowledge graph for the Packet Transport Network according to the KG 410 scheme.

The device 100, in some embodiments, obtains the trained model 120 based on one or more of the following machine learning algorithms:
alarm correlation rule mining using FP-Growth algorithm
multi-source correlation for incident candidate generation using the soft nearest neighbor classifier based on knowledge graph 410 driven features
knowledge graph embedding for feature extraction using structural deep network embedding algorithm
incident type classification using graph convolution network.

The training process of the device is performed based on the training phase discussed under the procedure 1000 of FIG. 10.

The device 100, in some embodiments, applies the association rule mining algorithm of FP-Growth to the alarm series, using transactions generated out of 30 seconds time-windows and physical topology information 215. The rules are verified by domain experts and stored along with incident type, root cause, and remediation action in the knowledge graph. Structural deep network embedding is trained to learn alarm features from the knowledge graph, and graph convolution network is trained to classify an incident candidate in terms of its type.

A detailed description of the combination scheme for these two types of the neural networks, along with their input/output, is discussed with respect to FIG. 5.

The training data at each time are based on the 9 out of 10 folds. The device 100 repeated the training process for 10 times using leave-one-fold-out for testing purposes (assessing the generalization of trained models).

The device 100, in some embodiments, grouped the alarms using 30 seconds time-window and topology information 215 to generate incident candidates 260. Features were extracted from each incident candidate based on one-hot-encoding of alarms, the proportion of each alarm in the incident, alarm sources, alarm seventies, order of alarm occurrence. These features are then mapped to the incident type of the incident candidate by a human expert, and the mapping is stored in the form of a training example in the training set.

The device 100, in some embodiments, obtained, the mean accuracy of 88.9%, mean precision of 70.5% and mean recall of 71.7%, based on 10-fold stratified cross-validation.

The dataset of the Packet Transport Network may be classified using a conventional multilayer perceptron (MLP) method. The MLP is generally known to the skilled person and is used merely as an example for comparing the performance results of the device 100.

The conventional MLP method yields a mean accuracy of 86.9%, a mean precision of 66.3%, and a mean recall of 66.7%, based on 10-fold stratified cross-validation.

From the obtained results, it can be derived that the precision and/or recall are improved on average by approximately 5%, as it can be generally derived by the skilled person. In some embodiments, it may be derived that the device 100 yields improvements in all three classification metrics.

When looking at mean accuracy, the highly unbalanced class distribution may need to be considered. The performance benefits of the device100 are demonstrated through the improvement of Recall and Precision alone.

Furthermore, the resource footprints when training the device 100 are shown in FIG. 11A and FIG. 11B.

FIG. 11A and FIG. 11B depict diagrams illustrating resource footprints when training the device 100. In particular, the required training time (FIG. 11A) and the required memory for the training process (FIG. 11B) are shown and compared for cases, wherein the device 100 is either trained using batches or epochs.

The diagram 1100A of FIG. 11A depicts a first line-chart 1101 representing the training time plotted on the left Y-axis versus the batch size plotted on the X-axis, when the training is performed using batches (i.e., sets of data from the dataset), according to some embodiments of the disclosure.

For example, when the device 100 is trained based on batches, for a batch size of 1, a training time of 0.055 second per batch is required. In some embodiments, for a batch size of 128, a training time of 0.288 second per batch is required.

The diagram 1100A of FIG. 11A further depicts a second line-chart 1102 representing the training time plotted on the right Y-axis versus the batch size plotted on the X-axis, when the training is performed based on epochs (i.e., the entire dataset).

For example, when the device 100 is trained using epochs (the entire dataset), for a batch size of 1, a training time of 28.482 seconds per epoch is required. Further, for a batch size of 128, a training time of 3.309 seconds per epoch is required.

The diagram 1100B of FIG. 11B shows a line-chart 1103 representing the used memory (for training) plotted on the Y-axis versus the batch size plotted on the X-axis. From diagram 1100B, it can be derived that the training of the device 100 with a batch size of 1 requires 2.966 Gigabytes (GB) of memory. Further, the training of the device 100 with a batch size of 128 requires 2.975 GB of memory.

Furthermore, a similar level of computation and memory resources is required, when using the conventional MLP method (for the sake of simplicity, the charts related to the MLP method are not shown in FIG. 11A and 11B).

The obtained data when using the conventional MLP method shows, however, that for a batch size of 1, a training time of 0.036 second per batch is required, when the training is performed based on batches. Similarly, for a batch size of 128, a training time of 0.310 second per batch is required.

In some embodiments, for a batch size of 1 and a batch size of 128, a training time of 23.116 and a training time of 3.175 seconds per epoch is required, respectively, when the training is based on epochs.

In some embodiments, in the case of the conventional MLP method, the trainings with a batch size of 1 and a batch size of 128 require 2.966 GB and 2.975 GB of memory, respectively.

In some embodiments, it may be concluded that a similar level of computation and memory resources is required for training, when using the device 100 and the conventional MLP method.

In some embodiments, it may be possible to achieve a better performance for a topology-based fault-propagation RCA by using the device 100. In some embodiments, there may be no need to increase the computational resources to improve performance of incident type classification.

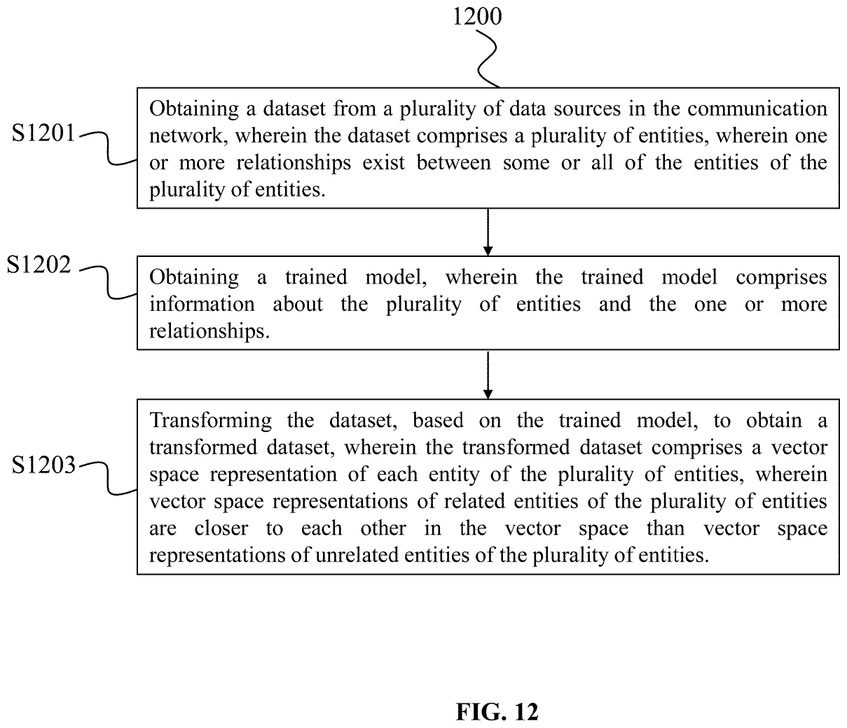

FIG. 12 shows a method 1200 according to an embodiment of the disclosure for monitoring a communication network, according to some embodiments of the disclosure. The method 1200 may be carried out by the device 100, as it is described above.

The method 1200 comprises a step S1201 of obtaining a dataset 110 from a plurality of data sources in the communication network 1.

The dataset 110 comprises a plurality of entities 111, 112, 113, 114, wherein one or more relationships exist between some or all of the entities of the plurality of entities 111, 112, 113, 114.

The method 1200 further comprises a step S1202 of obtaining a trained model 120.

The trained model 120 comprises information about the plurality of entities 111, 112, 113, 114 and the one or more relationships.

The method 1200 further comprises a step S1203 of transforming the dataset 110, based on the trained model 120, to obtain a transformed dataset 130.

The transformed dataset comprises a vector space representation 131, 132, 133, 134 of each entity of the plurality of entities 111, 112, 113, 114. In some embodiments, vector space representations of related entities of the plurality of entities 111, 112, 113, 114, 115 may be closer to each other in the vector space than vector space representations of unrelated entities of the plurality of entities 111, 112, 113, 114.

The present disclosure has been described in conjunction with various embodiments as examples as well as implementations. However, other variations can be understood and effected by those persons skilled in the art and practicing the various embodiments, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed:

1. A device for monitoring a communication network, comprising:
one or more processors; and
a nonvolatile memory coupled to the processors and storing program code, which when executed by the processor, cause the processors to:
obtain a dataset from a plurality of data sources in the communication network, wherein the dataset comprises a plurality of entities, wherein one or more relationships exist between one or more entities of the plurality of entities;
obtain a trained model, wherein the trained model comprises information about the plurality of entities and the one or more relationships; and
transform the dataset, based on the trained model, to obtain a transformed dataset, wherein the transformed dataset comprises a vector space representation of each entity of the plurality of entities,
wherein vector space representations of related entities of the plurality of entities are closer to each other in a vector space than vector space representations of unrelated entities of the plurality of entities.

2. The device of claim 1, wherein at least one of:
entities in the dataset that have a relationship to each other are transformed such that their vector space representations in the vector space have a smaller distance between each other, or
entities in the dataset that have no relationship to each other are transformed such that their vector space representations in the vector space have a larger distance between each other.

3. The device of claim 1, wherein the one or more processors are further configured to:
correlate the vector space representation of each entity in the vector space of the transformed dataset into groups; and
identify one or more incidents from the groups based on a trained classifier.

4. The device of claim 3, wherein the one or more processors are further configured to:
correlate the vector space representation of each entity into the groups based on at least one of a multi-source correlation rule or heuristic information.

5. The device according to claim 3, wherein the one or more processors are further configured to:
identify, for each of the one or more identified incidents, one or more of an incident type, a root cause of the incident, or an action to overcome the incident.

6. The device of claim 3, wherein the one or more processors are further configured to:
identify one or more incidents from the groups based on the trained classifier and topology information about the data sources in the communication network.

7. The device of claim 1, wherein the trained model further comprises a plurality of information triplets, each information triplet comprising at least one of a first entity, a second entity, or a relationship between the first entity and the second entity.

8. The device of claim 1, wherein the trained model further comprises, for each entity of the plurality of entities, at least one of information on at least one of a type of the entity, an incident associated with the type of the entity, an action to overcome the incident, or a root cause of the incident.

9. The device of claim 1, wherein the trained model further comprises graph-structured data.

10. The device of claim 1, wherein each of the plurality of entities correspond to one of an alarm, a key performance indicator value, a configuration management parameter, or log information.

11. The device of claim 1 wherein the one or more processors are further configured to:
transform the dataset based on the trained model by using a deep graph auto-encoder.

12. The device of claim 3, wherein the trained classifier is based on a soft nearest-neighbor classifier.

13. A method for monitoring a communication network, the method comprising:
obtaining a dataset from a plurality of data sources in the communication network, wherein the dataset comprises a plurality of entities, wherein one or more relationships exist between one or more of the entities of the plurality of entities;
obtaining a trained model, wherein the trained model comprises information about the plurality of entities and the one or more relationships; and
transforming the dataset, based on the trained model, to obtain a transformed dataset comprising a vector space representation of each entity of the plurality of entities,
wherein vector space representations of related entities of the plurality of entities are closer to each other in a vector space than vector space representations of unrelated entities of the plurality of entities.

14. The method of claim 13, wherein at least one of:
entities in the dataset that have a relationship to each other are transformed such that their vector space representations in the vector space have a smaller distance between each other, or
entities in the dataset that have no relationship to each other are transformed such that their vector space representations in the vector space have a larger distance between each other.

15. The method of claim 13, further comprising:
correlating the vector space representation of each entity in the vector space of the transformed dataset into groups; and
identifying one or more incidents from the groups based on a trained classifier.

16. The method of claim 15, further comprising:
correlating the vector space representation of each entity into the groups based on at least one of a multi-source correlation rule or heuristic information.

17. The method of claim 15, further comprising:
identifying, for each of the one or more identified incidents, one or more of an incident type, a root cause of the incident, or an action to overcome the incident.

18. The method of claim 15, wherein the identifying of the one or more incidents from the groups is further based on topology information about the data sources in the communication network.

19. The method of claim 13, wherein the trained model further comprises a plurality of information triplets, each information triplet comprising at least one of a first entity, a second entity, or a relationship between the first entity and the second entity.

20. A non-transitory machine-readable medium having instructions stored therein, which when executed by a processor, cause the processor to perform operations for monitoring a communication network, the operations comprising:
obtaining a dataset from a plurality of data sources in the communication network, wherein the dataset comprises a plurality of entities, wherein one or more relationships exist between one or more of the entities of the plurality of entities;
obtaining a trained model, wherein the trained model comprises information about the plurality of entities and the one or more relationships; and
transforming the dataset, based on the trained model, to obtain a transformed dataset comprising a vector space representation of each entity of the plurality of entities,
wherein vector space representations of related entities of the plurality of entities are closer to each other in a vector space than vector space representations of unrelated entities of the plurality of entities.
